(19) United States
(12) Patent Application Publication
(10) Pub. No.: US 2014/0345268 A1
(43) Pub. Date: Nov. 27, 2014

(54) TRAVEL CONTROL SYSTEM FOR CONSTRUCTION MACHINERY

(71) Applicant: Man-Seuk Jeon, Changwon-si (KR)

(72) Inventor: Man-Seuk Jeon, Changwon-si (KR)

(73) Assignee: VOLVO CONSTRUCTION EQUIPMENT AB, Eskilstuna (SE)

(21) Appl. No.: 14/365,575

(22) PCT Filed: Dec. 15, 2011
(86) PCT No.: PCT/KR2011/009667

§ 371 Date: Jun. 13, 2014

(51) Int. Cl. F15B 13/06

(52) U.S. Cl. CPC F15B 13/06
USPC 60/464

(57) ABSTRACT

A travel control system is disclosed for preventing off-course travel of equipment due to the overloading of a working piece such as a boom during a complex operation involving vehicle travel and simultaneous driving of the working piece. The travel control system according to the present invention comprises: a left-side travel motor and first working piece coupled to a first hydraulic pump; a plurality of change-over valves for respectively controlling operating fluid supplied from the first hydraulic pump to the left-side travel motor and first working piece; a right-side travel motor and second working piece coupled to a second hydraulic pump; a plurality of change-over valves for controlling operating fluid supplied from the second hydraulic pump to the right-side travel motor and second working piece; a straight-ahead travel valve for supplying the operating fluid of the first hydraulic pump to the left-side and right-side travel motors and supplying the operating fluid of the second hydraulic pump to the first and second working pieces; and a control valve for blocking the supply of operating fluid from the second hydraulic pump, via the straight-ahead travel valve, to the left-side travel motor and right-side travel motor during complex operation involving travel and the working piece.

### FIELD OF THE INVENTION

The present invention relates to traveling control system for a construction machine. More particularly, the present invention relates to a traveling control system for a construction machine, which can prevent a single traveling of the machine due to occurrence of an overload in an attachment (or work apparatus) such as a boom during a combined operation in which a traveling operation and a working operation are performed simultaneously.

### BACKGROUND OF THE INVENTION

A traveling control system for a construction machine in accordance with the prior art as shown in FIGS. 1 and 2 includes:

first and second variable displacement hydraulic pumps (hereinafter, “first and second hydraulic pumps”) 15 and 18;

a left traveling motor 2 that is connected to the first hydraulic pump 15 and is driven by being supplied with a hydraulic fluid, and a first attachment (not shown) such as an arm;

a plurality of switching valves 12 and 26 that are installed in a flow path 1 of the first hydraulic pump 15 and are shifted in response to pilot signal pressures a1 and b1 applied thereto to control a hydraulic fluid being supplied to the left traveling motor 2 to the first attachment;

a right traveling motor 3 that is connected to the second hydraulic pump 18 and is driven by being supplied with the hydraulic fluid, and a second attachment (not shown) such as a boom;

a plurality of switching valves 11 and 28 that are installed in a flow path 9 of the second hydraulic pump 18 and are shifted in response to pilot signal pressures a2 and b2 applied thereto to control a hydraulic fluid being supplied to the right traveling motor 3 or the second attachment; and

a straight traveling valve 4 that is installed in the flow path 9 and is shifted in response to a pilot signal pressure a3 to supply the hydraulic fluid discharged from the first hydraulic pump 15 to the left and right traveling motors 2 and 3 and to supply a part of the hydraulic fluid discharged from the second hydraulic pump 18 to the switching valve 26 for the first attachment through a flow path 32 and simultaneously supply a part of the hydraulic fluid discharged from the second hydraulic pump 18 to the switching valve 28 for the second attachment through the flow path 7, respectively.

A non-explained reference numeral 10 denotes a main relief valve that drains a hydraulic fluid of an excessive pressure to a hydraulic tank T when an overload exceeding a set pressure in a hydraulic circuit occurs, and a reference symbol s denotes a spool on the switching valve 11 for controlling the hydraulic fluid supplied to the right traveling motor 3.

A) The case of performing the traveling operation alone will be described hereinafter.

When the pilot signal pressure a1 is applied to the switching valve 12 for the left traveling motor, a spool of the switching valve 12 is shifted to the left on the drawing sheet. Thus, a hydraulic fluid discharged from the first hydraulic pump 15 is supplied to the left traveling motor 2 via the flow path 1, the switching valve 12, and a traveling line 14 in this order.

When the pilot signal pressure a2 is applied to the switching valve 11 for the right traveling motor, a spool of the switching valve 11 is shifted to the right on the drawing sheet. Thus, a hydraulic fluid discharged from the second hydraulic pump 18 is supplied to the right traveling motor 3 via the flow path 9, the switching valve 11, and a traveling line 20 in this order. In other words, in the case where the left traveling motor 2 or the right traveling motor 3 is driven alone, the hydraulic fluid discharged from the first hydraulic pump 15 is supplied to the left traveling motor 2, and the hydraulic fluid discharged from the second hydraulic pump 18 is supplied to the right traveling motor 3.

B) The case of performing the combined operation of the traveling operation and the working operation will be described hereinafter.

When the pilot signal pressure a3 is applied to the straight traveling valve 4, a spool of the straight traveling valve 4 is shifted to the right on the drawing sheet. At the same time, when the pilot signal pressure b1 is applied to the switching valve 26 for the first attachment, a spool of the switching valve 26 is shifted to the left on the drawing sheet. When a signal pressure c1 is applied to a first center bypass valve 22, a spool of the first center bypass valve 22 is shifted to the left on the drawing sheet to form a pressure in a first center bypass flow path.

Thus, apart of the hydraulic fluid from the first hydraulic pump 15 is supplied to the left traveling motor 2 via the flow path 1, the switching valve 12, and the traveling line 14 in this order. At the same time, a part of the hydraulic fluid from the first hydraulic pump 15 is supplied to the right traveling motor 3 via the flow path 9, the straight traveling valve 4, the switching valve 11, and the traveling line 20 in this order. That is, the hydraulic fluid discharged from the first hydraulic pump 15 is used to drive the left traveling motor 2 and the right traveling motor 3.

Meanwhile, the hydraulic fluid from the second hydraulic pump 18 is supplied to the switching valve 26 for the first attachment via the flow path 9, the straight traveling valve 4, and the flow path 32 in this order to drive a corresponding attachment (e.g., an arm). That is, the hydraulic fluid discharged from the second hydraulic pump 18 is used to drive a corresponding attachment by being supplied to the switching valve 26 for the first attachment.

Under the straight traveling condition as described above, when the spool of the switching valve 26 is shifted to a full stroke by gradually increasing a pressure needed to shift the switching valve 26 for the first attachment, the pressure rises up to the set pressure of the main relief valve 10. In this case, the hydraulic fluid from the second hydraulic pump 18 is not supplied to the switching valve 26 for the first attachment any more.

In other words, apart of the hydraulic fluid being supplied to the switching valve 26 is supplied to the right traveling motor 3 via the check valve 5 and the orifice 6 after passing through the flow path 32, the straight traveling valve 4, the flow path 9, and the flow path 7. In addition, a part of the hydraulic fluid being supplied to the switching valve 26 is supplied to the left traveling motor 2 via the flow path 8.

In this case, the switching valves 12 and 11 for the traveling motors are shifted in response to the pilot signal pressures a1 and a2 applied thereto. When the combined operation is performed, a pilot signal pressure on the traveling side is maintained at about 10-12K to shift the switching valves 11 and 12. For this reason, in case of an intermediate shift section, the switching valves 11 and 12 for the traveling motors can be controlled by a P-N notch (i.e., a notch that controls the hydraulic fluid flowing from the hydraulic pump to the hydraulic tank), a P-C notch (i.e., a notch that controls the hydraulic fluid flowing from the hydraulic pump to the hydraulic cylinder), and a C-T notch (i.e., a notch that controls the hydraulic fluid flowing from the hydraulic cylinder to the hydraulic tank).

In the structure of the conventional hydraulic circuit, in the case where the switching valve 26 and the first center bypass valve 22 are shifted, no hydraulic fluid flows by the P-N notch. For this reason, the switching valves 11 and 12 can be controlled by the P-C notch or the C-T notch. In this case, the spool notches of the switching valves 11 and 12 for the traveling motors have the same structure. On the other hand, it is difficult to maintain the same cross section due to a difference in the stack tolerance for processing the spool and the process conditions.

In other words, the flow rate of a hydraulic fluid passing through the spool is in proportion to the cross section of the spool. Thus, if there is a difference in cross section of the spool notch, the flow rates of the hydraulic fluids passing through the switching valves 12 and 11 for the traveling motors are different from each other. That is, if the flow rates of the hydraulic fluids passing through the switching valves 12 and 11 for the traveling motors are different from each other, the drive speed of the traveling motor through which a relatively large amount of hydraulic fluid passes is abruptly increased. On the contrary, the drive speed of the traveling motor through which a relatively small amount of hydraulic fluid passes is decreased.

As described above, the spools of the switching valves 12 and 11 for the traveling motors are shifted to an intermediate level to drive the traveling motors 2 and 3. In this case, the spool of the straight traveling valve 4 is in a state of having been completely shifted. At the same time, a single traveling of the machine is caused due to occurrence of an overload in the attachment during the combined operation in which the traveling operation and the working operation of an attachment such as a boom are performed.

In addition, when an attachment has a load applied thereto during the traveling of the machine (e.g., a state in which a heavy pipe or the like is lifted), it is not operated. That is, in the case where a boom or the like is operated during the traveling of the machine, when a great load occurs on the boom and a relatively small load occurs on the traveling side, the boom is not operated.

When the switching valve 26 for the attachment is shifted while driving the switching valves 12 and 11 for the traveling motors, the hydraulic fluid from the first hydraulic pump 15 drives the left traveling motor 2 and the hydraulic fluid from the second hydraulic pump 18 drives the right traveling motor 3. In this case, the straight traveling valve 4 is not shifted.

In the case where the switching valve 26 for the attachment is shifted, the straight traveling valve 4 is shifted by the pilot signal pressure a3. In this case, hydraulic fluid from the first hydraulic pump 15 is supplied to the switching valves 12 and 11 via the flow path 1 and the flow path 8, respectively. In addition, the hydraulic fluid from the second hydraulic pump 18 is supplied to the switching valve 26 via the flow path 9, and is supplied to the switching valve 11 after passing through the check valve 5 and the orifice 6 via the flow path 7.

Meanwhile, in the case where a great load occurs on the hydraulic fluid being supplied to switching valve 26 (e.g., the case in which an orifice is formed), i.e., an orifice smaller than the orifice 6 of the switching valve 11 side is installed, all the hydraulic fluids from the second hydraulic pump 18 are supplied to the switching valve 11. As a result, there is caused a problem in that the attachment of the switching valve 26 side is not driven.

In an attempt to address and solve the above-mentioned problem, a gap 16 defined between the outer periphery of a poppet 13 and the inner periphery of a body 17 of a switching valve is machined to have a small size to make the orifice 6 small as shown in FIG. 2. A non-explained reference numeral 19 denotes an elastic member (e.g., a compression coil spring) that presses the poppet 13 to elastically biases the poppet 13 to an initial state from the blocked state of the branch flow path 7a.

On the other hand, when the gap is machined to have a large size, the poppet 13 and the body 17 of the switching valve come into close contact with each other to cause a noise. For this reason, the gap 16 between the poppet 13 and the body 17 of the switching valve is machined to have a minimum size within a tolerance range in which any noise is not generated from the gap.

### DETAILED DESCRIPTION OF THE INVENTION

### Technical Problems

Accordingly, the present invention has been made to solve the aforementioned problem occurring in the prior art, and it is an object of the present invention to provide a traveling control system for a construction machine, which can prevent a single traveling of the machine due to occurrence of an overload in an attachment such as a boom during a combined operation in which a traveling operation and a working operation are performed simultaneously, and enables the combined operation of a traveling operation and a working operation to be performed even when a load occurs in the attachment

### Technical Solution

To accomplish the above object, in accordance with an embodiment of the present invention, there is provided a traveling control system for a construction machine in accordance with an embodiment of the present invention, the system including:

first and second variable displacement hydraulic pumps;

a left traveling motor connected to the first hydraulic pump and a first attachment;

a plurality of switching valves installed in a flow path 1 of the first hydraulic pump and configured to be shifted to control a hydraulic fluid being supplied to the left traveling motor and the first attachment;

a right traveling motor connected to the second hydraulic pump and a second attachment;

a plurality of switching valves installed in a flow path of the second hydraulic pump and configured to be shifted to control a hydraulic fluid being supplied to the right traveling motor and the second attachment;

a straight traveling valve installed in the flow path of the second hydraulic pump and configured to be shifted to supply the hydraulic fluid discharged from the first hydraulic pump to the left and right traveling motors and to supply the hydraulic fluid discharged from the second hydraulic pump to the first attachment and the second attachment, respectively; and

a control valve installed in a branch flow path having an inlet side that is connected to a flow path branched off from the flow path of the second hydraulic pump and an outlet side that is connected to the flow path of the second hydraulic pump on a downstream side of the straight traveling valve, and configured to serve as a check valve and an orifice so as to interrupt the supply of the hydraulic fluid from the second hydraulic pump to the left traveling motor and the right traveling motor via the straight traveling valve during a combined operation in which a traveling operation and a working operation are performed simultaneously.

In a preferred embodiment of the present invention, the control valve may include:

a first poppet configured to open/close the branch flow path that fluidically communicates with an inlet-side flow path of the switching valve for the traveling motor, the first poppet having a first orifice formed thereon;

a second poppet installed inside the first poppet and having a second orifice formed thereon;

an elastic member configured to allow the second poppet to be pressed against the first poppet to elastically support the second poppet in a state in which a flow path of the first poppet is closed; and

a flange securely fixed to a body of the control valve to support the elastic member so as to allow the first and second poppet to be kept at set pressures thereof.

A control valve that is shifted to an on/off state to open/close the pilot signal line in response to a control signal applied from the outside may be used as a valve installed on a pilot signal line for supplying a pilot signal pressure to the straight traveling valve to shift the straight traveling valve.

An electronic proportional valve that outputs a secondary pilot signal pressure generated during the driving in proportion to a control signal applied from the outside may be used as a valve installed on a pilot signal line for supplying pilot signal pressure to the straight traveling valve to shift the straight traveling valve.

The first attachment connected to the first hydraulic pump may be any one selected from a boom, an arm, a bucket, a swing motor, and a winch motor.

The control valve may include a tapered portion formed on the outer surface of the first poppet that is in close contact with the body of the control valve to serve as a damper when the branch flow path is blocked through the mutual close contact between the first poppet and the body of the control valve.

The control valve may include a notch portion formed on the outer surface of the first poppet that is in close contact with the body of the control valve to serve as a damper when the branch flow path is blocked through mutual close contact between the first poppet and the body of the control valve.

The control valve may include a sealing O-ring that prevents the hydraulic fluid from leaking to the outside through a gap of a close contact surface between the body of the control valve and the flange.

### Advantageous Effect

The travel control system for a construction machine in accordance with an embodiment of the present invention as constructed above has the following advantages.

It is possible to prevent a single traveling of the machine due to occurrence of an overload in an attachment such as a boom, and ensure the workability of the attachment, thereby improving the manipulability of the attachment during a combined operation in which a traveling operation and a working operation are performed simultaneously. In addition, when an operation mode is switched to a neutral position, occurrence of a shock can be prevented and the manufacturing cost can be reduced owing to simplicity of the structure.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a hydraulic circuit diagram showing a traveling control system for a construction machine in accordance with the prior art;

FIG. 2 is an exploded cross-sectional view showing a main element of a switching valve for traveling shown in FIG. 1; and

FIG. 3 is an exploded cross-sectional view showing a main element of a switching valve for traveling in a control system for a construction machine in accordance with an embodiment of the present invention.

### EXPLANATION ON REFERENCE NUMERALS OF MAIN ELEMENTS IN THE DRAWINGS

7a: branch flow path
30: control valve
31: first orifice
32: first poppet
33: second orifice
34: second poppet
35: elastic member
36: fastening member
37: flange
38: O-ring

### PREFERRED EMBODIMENTS OF THE INVENTION

Now, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

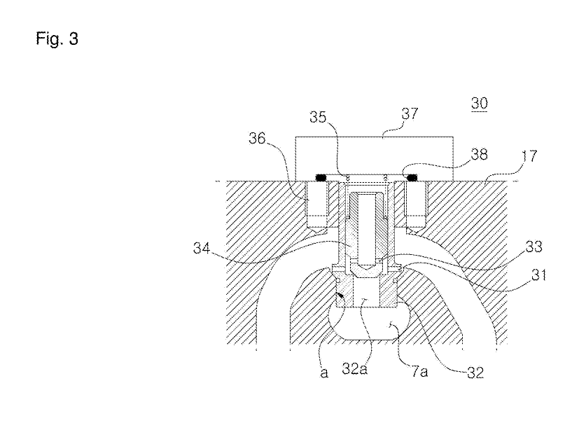

As shown in FIG. 3, a traveling control system for a construction machine in accordance with an embodiment of the present invention includes:

first and second variable displacement hydraulic pumps (hereinafter, “first and second hydraulic pumps”) 15 and 18;

a left traveling motor 2 that is connected to the first hydraulic pump 15 and a first attachment (e.g., an arm);

a plurality of switching valves 12 and 26 that are installed in a flow path 1 of the first hydraulic pump 15 and are shifted to control a hydraulic fluid being supplied to the left traveling motor 2 and the first attachment;

a right traveling motor 3 that is connected to the second hydraulic pump 18 and a second attachment (e.g., a boom);

a plurality of switching valves 11 and 28 that are installed in a flow path 9 of the second hydraulic pump 18 and are shifted to control a hydraulic fluid being supplied to the right traveling motor 3 and the second attachment;

a straight traveling valve 4 that is installed in the flow path 9 of the second hydraulic pump 18 and is shifted to supply the hydraulic fluid discharged from the first hydraulic pump 15 to the left and right traveling motors 2 and 3 and to supply the hydraulic fluid discharged from the second hydraulic pump 18 to the first attachment and the second attachment, respectively; and

a control valve 30 that is installed in a branch flow path 7a having an inlet side that is connected to a flow path 7 branched off from the flow path 9 of the second hydraulic pump 18 and an outlet side that is connected to the flow path 9 of the second hydraulic pump 18 on a downstream side of the straight traveling valve 4, and serves as a check valve and an orifice so as to interrupt the supply of the hydraulic fluid from the second hydraulic pump 18 to the left traveling motor 2 and the right traveling motor 3 via the straight traveling valve 4 during a combined operation in which a traveling operation and a working operation are performed simultaneously.

The control valve 30 includes:

a first poppet 32 that opens/closes the branch flow path 7a that fluidically communicates with an inlet-side flow path of the switching valve 11 for the right traveling motor, the first poppet having a first orifice 31 formed thereon;

a second poppet 34 that is installed inside the first poppet 32 and having a second orifice 33 formed thereon;

an elastic member (e.g., a compression coil spring) 35 that allows the second poppet 34 to be pressed against the first poppet 32 to elastically support the second poppet 34 in a state in which a flow path 32a of the first poppet 32 is closed; and

a flange 37 that is securely fixed to a body 17 of the control valve by means of a fastening member (e.g., a bolt) to support the elastic member 35 so as to allow the first and second poppet 34 to be kept at set pressures thereof.

A control valve (not shown) that is shifted to an on/off state to open/close the pilot signal line in response to a control signal applied from the outside may be used as a valve installed on a pilot signal line for supplying a pilot signal pressure to the straight traveling valve 4 to shift the straight traveling valve 4.

An electronic proportional valve (not shown) that outputs a secondary pilot signal pressure generated during the driving in proportion to a control signal applied from the outside may be used as a valve installed on a pilot signal line for supplying pilot signal pressure to the straight traveling valve 4 to shift the straight traveling valve 4.

The first attachment connected to the first hydraulic pump 15 is any one selected from a boom, an arm, a bucket, a swing motor, and a winch motor, except the traveling motors.

The control valve 30 includes a tapered portion (not shown) formed on the outer surface of the first poppet 32 that is in close contact with the body 17 of the control valve to serve as a damper when the branch flow path 7a is blocked through the mutual close contact between the first poppet 32 and the body 17 of the control valve.

The control valve 30 includes a notch portion (not shown) formed on the outer surface of the first poppet 32 that is in close contact with the body 17 of the control valve to serve as a damper when the branch flow path 7a is blocked through mutual close contact between the first poppet 32 and the body 17 of the control valve.

The control valve system further includes a sealing O-ring that prevents the hydraulic fluid from leaking to the outside through a gap of a close contact surface between the body 17 of the control valve and the flange 37.

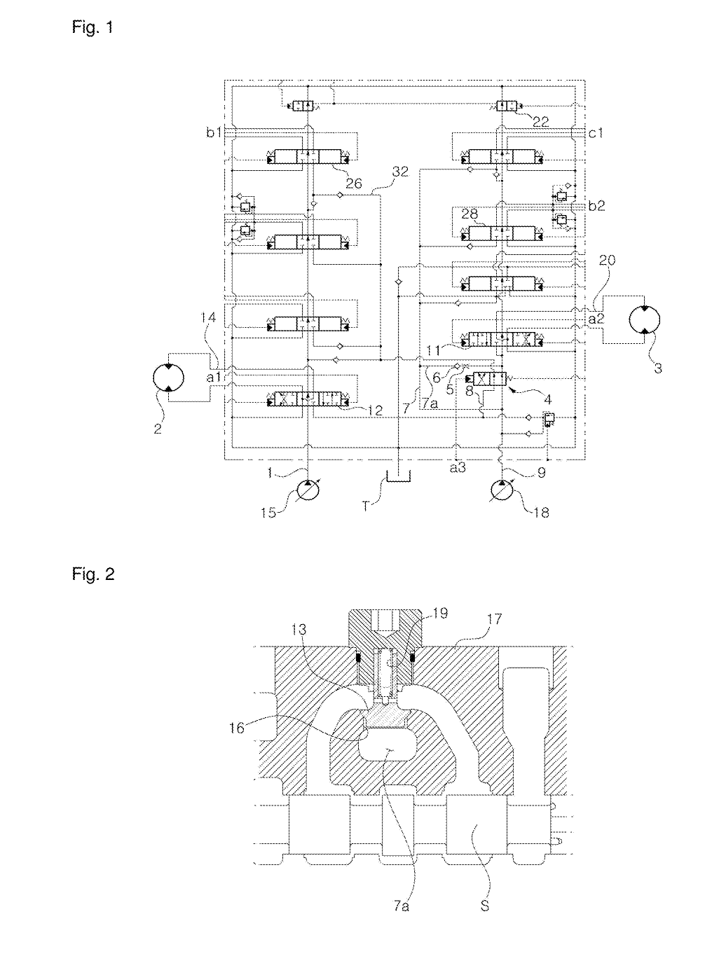

In this case, a configuration of a control system for a construction machine in accordance with an embodiment of the present invention is the same as that of the hydraulic system shown in FIG. 1, except the control valve 30 that is installed in a branch flow path 7a and serves as a check valve and an orifice so as to prevent a single traveling of the machine during a combined operation in which a traveling operation and a working operation are performed simultaneously. Thus, the detailed description of the same configuration and operation thereof will be omitted to avoid redundancy, and the same elements are denoted by the same reference numerals.

Hereinafter, a use example of a traveling control system for a construction machine in accordance with an embodiment of the present invention will be described in detail with reference to the accompanying drawings.

As shown in FIG. 3, a case of a combined operation in which an attachment such as an arm is driven during the traveling of the machine will be described hereinafter.

When a spool inside the straight traveling valve 4 is shifted to the right on the drawing sheet of FIG. 1 in response to a pilot signal pressure a3 applied to the straight traveling valve 4, a hydraulic fluid discharge from the first hydraulic pump 15 is supplied to the left traveling motor 2 via the flow path 1, the switching valve 12, and a traveling line 14 in this order. In addition, the hydraulic fluid from the first hydraulic pump 15 is supplied to the right traveling motor 3 via the flow path 8, the straight traveling valve 4, the switching valve 11, and a traveling line 20 in this order, so that these elements are driven, respectively.

At the same time, a hydraulic fluid discharge from the second hydraulic pump 18 is supplied to an attachment such as an arm via the flow path 9, the straight traveling valve 4, a flow path 32, and the switching valve 26 in this order. In addition, the hydraulic fluid from the second hydraulic pump 18 is moved to the flow path 7 via the flow path 32, the straight traveling valve 4, and the flow path 9 in this order. The hydraulic fluid moved to the flow path 7 sequentially passes through a check valve 5 and an orifice 6 that are installed in the branch flow path 7a.

In other words, the hydraulic fluid from the second hydraulic pump 18 is moved to the branch flow path 7a to cause the first poppet 32 to be pushed to the top on the drawing sheet due to a difference in cross section between the second poppet 34 and a pressure-receiving portion, so that the branch flow path 7a is opened. At this time, the second poppet 34 is closed by an elastic force of the elastic member 35 to cause the flow path 32a of the first poppet 32 to be blocked.

In this case, a stroke of the first poppet 32 is small, and thus the hydraulic fluid in the branch flow path 7a passes through a gap (a) defined between the first poppet 32 and the body 17 of the control valve 30. That is, the hydraulic fluid in the branch flow path 7a passes through the tapered portion or the notch portion formed on the first poppet 32. The second poppet 34 is pushed to the top on the drawing sheet to open the flow path 32a by a pressure introduced into the flow path 32a of the first poppet 32 due to an increase in pressure of the branch flow path 7a.

Thus, a part of the hydraulic fluid in the branch flow path 7a passes through the flow path 32a and the first orifice 31 that are formed in the first poppet 32, and simultaneously passes through the gap (a) defined between the first poppet 32 an the body 17 of the control valve 30.

Meanwhile, in the case where the supply of the hydraulic fluid to the branch flow path 7a is interrupted, the first poppet 32 returns to an initial position to cause the first poppet 32 an the body 17 of the control valve 30 to come into close contact with each other, so that the branch flow path 7a is blocked and then the second poppet 34 returns to an initial position by an elastic restoring force of the elastic member 35 to block the flow path 32a of the first poppet 32. In other words, when the supply of the hydraulic fluid to the branch flow path 7a is interrupted, the first poppet 32 and the second poppet 34 are sequentially blocked. Thus, it is possible to prevent a shock (frequently occurring when the operation mode is switched to a neutral position after manipulating a manipulation lever (i.e., RCV lever)) from occurring when the first poppet 32 and the body 17 of the control valve 30 come into close contact with each other.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

### INDUSTRIAL APPLICABILITY

As described above, according to the present invention as constructed above, it is possible to prevent a single traveling of the machine due to occurrence of an overload in an attachment such as a boom, and ensure the workability of the attachment, thereby improving the manipulability of the attachment during a combined operation in which a traveling operation and a working operation are performed simultaneously.

1. A traveling control system for a construction machine, comprising:
first and second variable displacement hydraulic pumps;
a left traveling motor connected to the first hydraulic pump and a first attachment;
a plurality of switching valves installed in a flow path of the first hydraulic pump and configured to be shifted to control a hydraulic fluid being supplied to the left traveling motor and the first attachment;
a right traveling motor connected to the second hydraulic pump and a second attachment;
a plurality of switching valves installed in a flow path of the second hydraulic pump and configured to be shifted to control a hydraulic fluid being supplied to the right traveling motor and the second attachment;
a straight traveling valve installed in the flow path of the second hydraulic pump and configured to be shifted to supply the hydraulic fluid discharged from the first hydraulic pump to the left and right traveling motors and to supply the hydraulic fluid discharged from the second hydraulic pump to the first attachment and the second attachment, respectively; and
a control valve installed in a branch flow path having an inlet side that is connected to a flow path branched off from the flow path of the second hydraulic pump and an outlet side that is connected to the flow path of the second hydraulic pump on a downstream side of the straight traveling valve, and configured to serve as a check valve and an orifice so as to interrupt the supply of the hydraulic fluid from the second hydraulic pump to the left traveling motor and the right traveling motor via the straight traveling valve during a combined operation in which a traveling operation and a working operation are performed simultaneously.

2. The traveling control system for a construction machine according to claim 1, wherein the control valve comprises:
a first poppet configured to open/close the branch flow path that fluidically communicates with an inlet-side flow path of the switching valve for the traveling motor, the first poppet having a first orifice formed thereon;
a second poppet installed inside the first poppet and having a second orifice 33 formed thereon;
an elastic member configured to allow the second poppet to be pressed against the first poppet to elastically support the second poppet in a state in which a flow path of the first poppet is closed; and
a flange securely fixed to a body of the control valve to support the elastic member so as to allow the first and second poppet to be kept at set pressures thereof.

3. The traveling control system for a construction machine according to claim 1, wherein a control valve that is shifted to an on/off state to open/close the pilot signal line in response to a control signal applied from the outside is used as a valve installed on a pilot signal line for supplying a pilot signal pressure to the straight traveling valve to shift the straight traveling valve.

4. The traveling control system for a construction machine according to claim 1, wherein an electronic proportional valve that outputs a secondary pilot signal pressure generated during the driving in proportion to a control signal applied from the outside is used as a valve installed on a pilot signal line for supplying pilot signal pressure to the straight traveling valve to shift the straight traveling valve.

5. The traveling control system for a construction machine according to claim 1, wherein the first attachment connected to the first hydraulic pump is any one selected from a boom, an arm, a bucket, a swing motor, and a winch motor.

6. The traveling control system for a construction machine according to claim 1, wherein the control valve includes a tapered portion formed on the outer surface of the first poppet that is in close contact with the body of the control valve to serve as a damper when the branch flow path is blocked through the mutual close contact between the first poppet and the body of the control valve.

7. The traveling control system for a construction machine according to claim 1, wherein the control valve includes a notch portion formed on the outer surface of the first poppet that is in close contact with the body of the control valve to serve as a damper when the branch flow path is blocked through mutual close contact between the first poppet and the body of the control valve.

8. The traveling control system for a construction machine according to claim 1, further comprising a sealing O-ring that prevents the hydraulic fluid from leaking to the outside through a gap of a close contact surface between the body of the control valve and the flange.
